(19) United States
(12) Patent Application Publication
(10) Pub. No.: US 2025/0106055 A1
(43) Pub. Date: Mar. 27, 2025

(54) ETHERNET SWITCH BOX WITH HIGH VOLTAGE INPUT

(71) Applicant: Joby Aero, Inc., Santa Cruz, CA (US)

(72) Inventors: Nathaniel Martin, Alameda, CA (US); Ross Anthony Pimentel, San Carlos, CA (US)

(21) Appl. No.: 18/896,415

(22) Filed: Sep. 25, 2024

Related U.S. Application Data
(60) Provisional application No. 63/585,170, filed on Sep. 25, 2023.

(51) Int. Cl. H04L 12/10; G06F 1/20; H04L 12/40

(52) U.S. Cl. CPC H04L 12/10; G06F 1/206; H04L 12/40045

(57) ABSTRACT

A power over Ethernet (POE) switch provides integrated power and data transmission tailored for aircraft systems. The POE switch accepts high voltage input from batteries and utilizes DC-DC converters to generate low voltage for switch electronics. This power is combined with Ethernet data signals and delivered over Ethernet cabling to connected devices. To manage substantial heat generation, the switch employs thermally isolated zones with dedicated heatsinks and forced airflow paths for each hot section. Noise isolation techniques including filters and transformers prevent electrical noise from degrading network signals. Independent cooling paths and noise mitigation enable reliable operation despite the challenging thermal and electrical environment. The integrated networking, power distribution, thermal management, and noise isolation reduce cabling needs. The tailored POE switch design provides robust power and data transmission for aviation components without adding significant weight or complexity.

### CROSS-REFERENCE TO RELATED APPLICATION

This patent application claims the benefit of U.S. Provisional Patent Application No. 63/585,170, filed Sep. 25, 2023, which is incorporated by reference herein in its entirety.

### BACKGROUND

Aircraft require electrical power and data distribution systems for operation. Traditionally, separate systems have been used for power distribution and data networking on aircraft. For power, high voltage from batteries is converted to low voltage and distributed to components. For data, various data buses and networks such as Ethernet have been used to connect avionics components.

Increasingly, aircraft utilize fly-by-wire control systems where flight control surfaces and other components are actuated based on data sent over networks rather than direct mechanical linkages. This requires reliable and robust data networking on board the aircraft. At the same time, the growing number of electrical components on modern aircraft requires power distribution systems capable of delivering adequate power.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aircraft control system for an aircraft, including a power over Ethernet (POE) switch.

FIG. 2 is a block diagram of a POE switch, according to some examples, showing components of the POE switch in relation to thermal management design.

FIG. 3 is a block diagram illustrating noise isolation components of a POE switch, according to some examples.

FIG. 4 is a plan view of a vertical takeoff and landing (VTOL) aircraft according to some examples, which may comprise the aircraft shown in FIG. 1.

FIG. 5 is a schematic view of an aircraft energy storage system, according to some examples.

FIG. 6 illustrates an electrical architecture for an aircraft, according to some examples.

FIG. 7 illustrates a diagrammatic representation of a machine in the form of a computer system within which a set of instructions may be executed for causing the machine to perform any one or more of the methodologies discussed herein, according to some examples.

### DETAILED DESCRIPTION

### Overview

According to some examples, there is described a power over Ethernet (POE) switch for use in electric vehicle (e.g., aviation) applications. The POE switch provides both Ethernet data connectivity and power sourcing over the same Ethernet cable. This enables an integrated power and data architecture with reduced cabling for aircraft systems.

In some examples, the POE switch accepts high voltage input from aircraft batteries and contains direct current to direct current (DC-DC) converters to transform this down to a low voltage suitable for electronics. The low-voltage power is combined with Ethernet data signals and delivered to connected devices over Ethernet cabling.

To manage the substantial heat generation from power conversion circuits, some examples of the POE switch utilizes multiple thermally isolated zones with dedicated heatsinks and forced airflow paths. This tailored cooling prevents overheating of components.

Additionally, in some examples, noise isolation techniques such as filters and transformers are employed to prevent electrical noise generated by the DC-DC converters from coupling into sensitive network data signals.

The POE switch, according to some examples, integrates networking, power distribution, thermal management, and noise isolation in a ruggedized enclosure to provide robust performance in aviation environments. The tailored design enables reliable power and data transmission for aircraft systems and components.

With reference to some examples, described herein is an aviation-grade POE switch with advanced thermal and noise management capabilities to deliver integrated power and data in a compact and reliable system. The POE switch architecture minimizes cabling needs and provides a flexible power and networking solution optimized for aircraft.

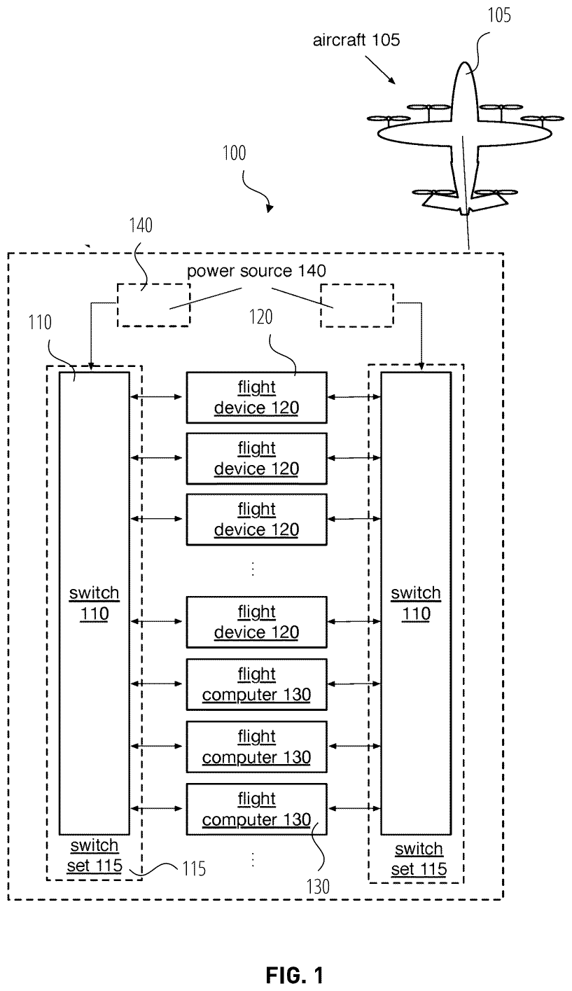

FIG. 1 shows an aircraft control system 100 for an aircraft 105, the aircraft control system 100 including flight devices 120, flight computers 130, a distribution network with PoE switches 110, and a power source 140 connected to the distribution network. The distribution network utilizes power over Ethernet to provide data connectivity and power to the flight devices 120 and flight computers 130.

Specifically, the PoE switches 110 in the distribution network are configured to provide Ethernet data transmission and PoE power sourcing over the same cable, such as to flight components of the aircraft 105. In some examples, the physical connections between the PoE switches 110, the flight devices 120 and the flight computers 130 are Ethernet cables that share power and data transmission.

The PoE switches 110 can provide various power levels to components, such as 13 watts (W), 20 W, or up to 100 W. The flight devices 120 and the flight computers 130 are powered devices that receive both data and power from the PoE switches 110 over the Ethernet cabling. This enables an integrated power and data architecture that minimizes cables and connectors.

The PoE switches 110 are central networking components in the aircraft control system architecture. The PoE switches 110 provide both Ethernet data transmission and power sourcing over the same Ethernet cable to flight components such as flight computers 130 and flight devices 120. Specifically, the PoE switches 110 accept high voltage input from the power sources 140, which are batteries providing 450-730 volts (V). The PoE switches 110 contain DC-DC converters to convert this high voltage down to low voltage, such as 55-62V. The low voltage power is then combined with Ethernet data transmission and output over the same cable to flight components.

The PoE switches 110 may also use an Ethernet variant such as 10 Mbit/s or gigabit Ethernet for data transmission. The PoE power sourcing can conform to standards such as 802.3af-2003 or 802.3at-2009 to deliver power levels from 13 W to 100 W. The PoE switches 110 are further designed to address thermal concerns and electrical noise issues. Thermal management techniques include separating hot components and providing multiple thermal paths to air. Electrical noise isolation includes careful electronics design to prevent noise from the DC-DC conversion from interfering with the network data signals.

### Thermal Management Design

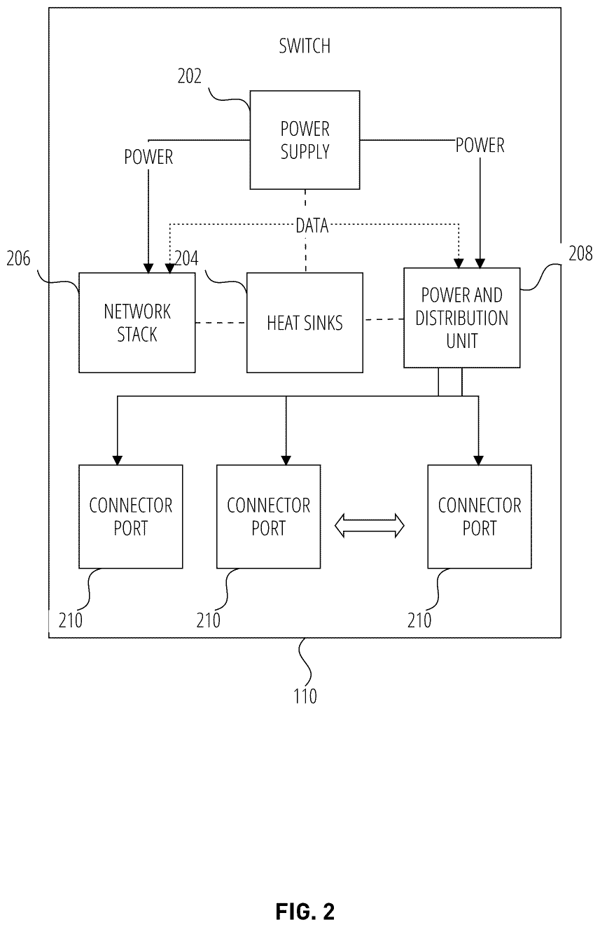

FIG. 2 is a block diagram of a POE switch 110, according to some examples, showing components of the POE switch 110 in relation to thermal management design. The POE switch 110 contains several key components that enable it to provide integrated power and data distribution, namely a power supply 202, one or more heat sinks 204, a network stack 206, a power and distribution unit 208, and multiple connector ports 210.

The power supply 202 may be implemented as a DC-DC converter module (e.g., including DC-DC converters 300) that accepts high voltage input from the batteries in the 450-730V range and converts it to a low voltage output of 55-62V. In some examples, the DC-DC converter uses a switching topology to transform the voltage, such as a buck converter, flyback converter, or isolated forward converter circuit. The power supply 202 is designed to provide up to 100 W of output power.

The network stack 206 contains the Ethernet switch integrated circuits and related networking hardware. These may include, merely for example, Ethernet switch chips such as the Marvell Prestera 98CX8512 to provide the layer 2 switching functionality. The switch chips support multiple Ethernet interfaces up to 10 Gigabit speeds. The network stack 206 also contains Ethernet physical layers (Ethernet PHYs) to convert between the switch chip's internal digital signals and the analog signals needed for the external Ethernet cabling. The PHYS provide signal integrity for transmission over the cables. Additionally, magnetics modules with transformers and chokes condition and isolate the PHY signals.

For management capabilities, the network stack 206 also incorporates an integrated management processor. This may be implemented, for example, with an ARM-based microcontroller that runs firmware to control the Ethernet switch chips, monitor port status, collect statistics, and interface with the system management.

The network stack 206 is connected to the power and distribution unit 208 over, for example, a 1000Base-T link. This allows the Ethernet data signals from the network stack to be combined with the power signals in the PoE section before being output over the connector ports 210. The management processor can communicate with the PoE controller integrated circuits (ICs) as well to coordinate power management functions.

In this way, the network stack 206 provides the data connectivity to integrate with the power distribution capabilities of the POE switch 110, enabling a unified power and data solution. The components work together to deliver robust wired networking and power sourcing tailored for aircraft applications.

The low-voltage power is fed from the power supply 202 to the power and distribution unit 208, which contains PoE power sourcing equipment (PSE). This includes PoE controller ICs such as the MAX5945 and power FETs to inject the DC power onto the Ethernet cable. The power and distribution unit 208 combines this power with the Ethernet data signals from the integrated network switch, provided over a 1000Base-T internal interface. The integrated circuitry handles PoE negotiation with powered devices (PDs) to deliver 13-100 W power levels.

Finally, the connector ports 210 deliver the integrated power and data to external flight components of the aircraft 105 over standard Ethernet cabling. Multiple connector ports are provided, implemented with RJ45 or avionics-grade connectors for reliability. The connector ports 210 may use category 5e or higher twisted-pair Ethernet cable to handle the power and data transmission.

To manage the substantial heat dissipation from the high-power DC-DC conversion in the power supply 202, some examples of the POE switch 110 incorporates several heat sinks 204 with fins and fans to spread and force air to cool the various hot components. In some examples, the heat sinks 204 include a primary heat sink 204, a secondary heat sink 204, and a tertiary heat sink 204. A primary heat sink 204 is thermally coupled to the power supply 202 to isolate its heat from other sections of the switch 110. The heat sink 204 has a large surface area to dissipate the heat load from the DC-DC converters and power devices. It uses a fan to force airflow over the fins to remove heat by convection. Thermal interface material such as thermal grease or thermal gap pads are applied between power components and the heat sink to maximize heat transfer.

The network stack 206 also generates significant heat from the Ethernet switch chips and PHYs. This section is thermally isolated from the power supply and equipped with its own dedicated heat sink 204 to dissipate heat. Thermal interface material transfers heat from the ICs to this secondary heat sink 204. A fan provides forced airflow over the network stack heat sink fins.

Additionally, the power and distribution unit 208 contains PoE controller ICs and power field-effect transistors (FETs) that require heatsinking located in proximity to those devices. A tertiary heat sink 204 dissipates heat from the power and distribution unit 208. Fans blow air over this tertiary heat sink 204 as well.

The POE switch 110 may further include several thermally isolated zones to independently cool its hot components. The power supply 202, containing the heat-generating DC-DC converters, is segregated into its own thermal zone. The primary heat sink 204 with fins is dedicated to the power supply zone. An inlet vent on the bottom draws cool ambient air across this heat sink 204, which absorbs heat from the power components through thermal interface material. The air is heated as it passes through the fins. An outlet vent on the top exhausts this warmed air out of the power supply zone.

The network stack 206 is partitioned into its own isolated thermal zone to prevent heating from the power supply. The secondary heat sink 204, thermally coupled to the Ethernet switch ICs and PHYs, is in this zone. Cool inlet air is drawn through vents across the network stack heatsink to remove heat. Baffles between the two zones block airflow from mixing. The warm outlet air exits through vents at the top.

A third thermal zone houses the power and distribution unit 208. The PoE controller ICs and power FETs mount onto the tertiary heat sink 204, which air flows across to provide cooling. Inlet and outlet vents route the air through this zone.

The internal layout divides the three zones. Baffles and airflow channels maintain the thermal isolation by blocking heat transfer between zones. The inlet vents are positioned on the bottom at opposite ends, while outlets vents are located on top. This separation enables ambient air to flow directly through each zone for maximum heat removal.

By thermally isolating the heat-producing components with independent heat sinks and airflow paths, the design of the POE switch 110 maintains temperatures within safe operating limits. The tailored cooling prevents overheating and enables reliable performance despite a challenging thermal environment.

### Noise Isolation Design

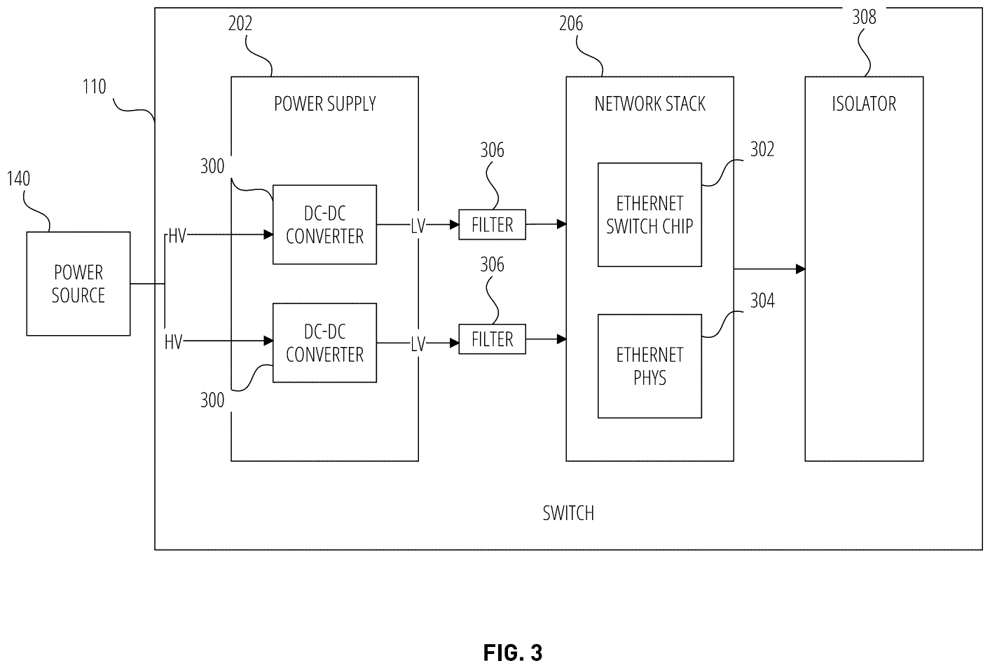

FIG. 3 is a block diagram illustrating noise isolation components of the POE switch 110, according to some examples. The POE switch 110 receives input power from the power source 140, which is connected to the power supply 202 containing DC-DC converters 300. The DC-DC converters 300 accept the high voltage input from the power source 140 and convert it to a low voltage output suitable for the switch electronics. However, the switching action of the DC-DC converters 300 can produce electrical noise.

To prevent this noise from coupling into sensitive network components, filters 306 are coupled at the output of each DC-DC converter 300. The filters 306 are designed to attenuate high-frequency noise while passing the desired DC voltage with minimal loss. Components such as inductors, capacitors, and resistors are selected and architected to optimize noise attenuation in the frequency bands that would affect network performance.

The low-noise DC output from the filters 306 is fed to the network stack 206 containing the core Ethernet switch chips 302 and Ethernet PHYs 304. The Ethernet switch chip 302 provides the Layer 2 (or the Data Link Layer in the OSI model) switching functionality while the Ethernet PHYs 304 transmit and receive signals over the Ethernet cables.

For additional noise isolation, in some examples an isolator 308 is placed between the Ethernet switch chips 302 and the Ethernet PHYs 304 and the rest of the POE switch 110. The isolator 308 contains transformers, optical components, or both, that are designed to electrically isolate the network signals passing between the network stack 206 and other POE switch 110 sections. This noise isolation prevents ground loops or other shared impedances from coupling noise into the data paths.

By combining filters 306 to clean the DC power with an isolator 308 around the network stack 206, the POE switch 110 provides robust noise isolation between the power and data sections. This enables reliable Ethernet connectivity without degradation from electrical noise.

### Example Vehicle Overview

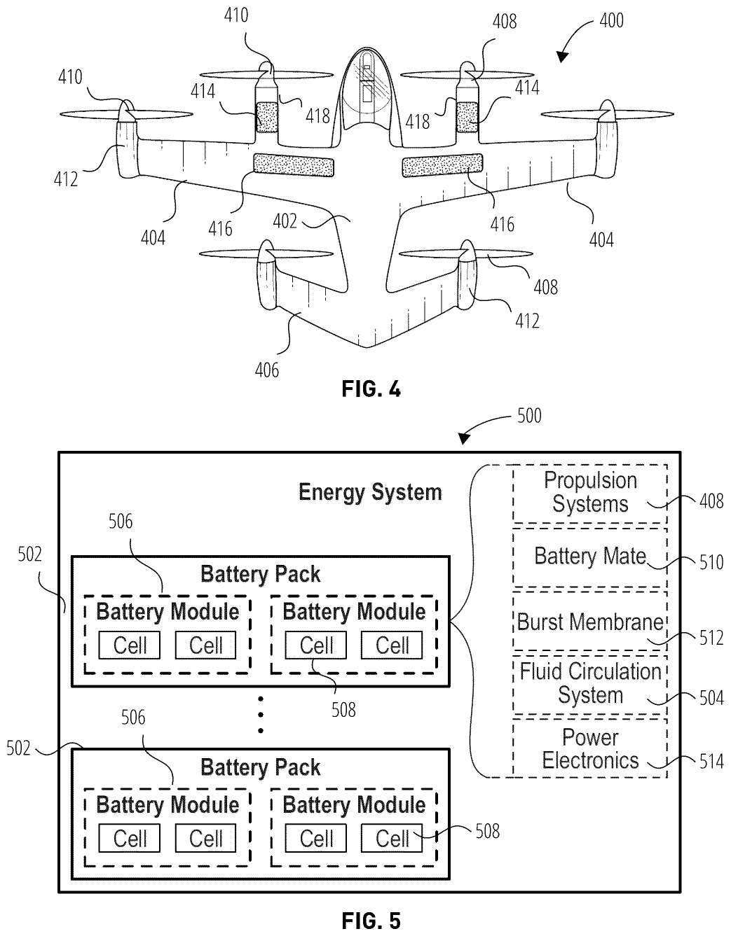

FIG. 4 is a plan view of a vertical takeoff and landing (VTOL) aircraft 400 according to some examples, which may comprise the aircraft 105. The aircraft 400 includes a fuselage 402, two wings 404, an empennage 406, and propulsion systems 408 embodied as tiltable rotor assemblies 410 located in nacelles 412. The aircraft 400 includes one or more nonlinear and isolated power sources in the example form of battery packs 502 (as shown in FIG. 5) embodied in FIG. 4 as nacelle battery packs 414 and wing battery packs 416. In the illustrated example, the nacelle battery packs 414 are located in inboard nacelles 418, but it will be appreciated that the nacelle battery packs 414 could be located in other nacelles 412 forming part of the aircraft 400. The aircraft 400 will typically include associated equipment such as an electronic infrastructure, control surfaces, a cooling system, landing gear, and so forth.

The wings 404 function to generate lift to support the aircraft 400 during forward flight. The wings 404 can additionally or alternately function to structurally support the battery packs 502, battery module 506 and/or propulsion systems 408 under the influence of various structural stresses (e.g., aerodynamic forces, gravitational forces, propulsive forces, external point loads, distributed loads, and/or body forces, and so forth).

### Energy Storage System

FIG. 5 is a schematic view of an aircraft energy storage system 500 according to some examples, which may be managed by an energy management system (EMS). As shown, the energy storage system 500 includes one or more battery packs 502. Each battery pack 502 may include one or more battery modules 506, which in turn may comprise a number of cells 508.

Typically associated with a battery pack 502 are one or more propulsion systems 408, a battery mate 510 for connecting it to the energy storage system 500, a burst membrane 512 as part of a venting system, a fluid circulation system 504 for cooling, and power electronics 514 for regulating delivery of electrical power (from the battery during operation and to the battery during charging) and to provide integration of the battery pack 502 with the electronic infrastructure of the energy storage system 500. As discussed in more detail below, the propulsion systems 408 may comprise multiple rotor assemblies.

The electronic infrastructure and the power electronics 514 can additionally or alternately function to integrate the battery packs 502 into the energy storage system 500 of the aircraft. The electronic infrastructure can include a battery management system (BMS), power electronics (high-voltage (HV) architecture, power components, and so forth), low-voltage (LV) architecture (e.g., vehicle wire harness, data connections, and so forth), and/or any other suitable components. The electronic infrastructure can include inter-module electrical connections, which can transmit power and/or data between battery packs and/or modules. Inter-modules can include bulkhead connections, bus bars, wire harnessing, and/or any other suitable components.

The battery packs 502 function to store electrochemical energy in a rechargeable manner for supply to the propulsion systems 408. Battery packs 502 can be arranged and/or distributed about the aircraft in any suitable manner. Battery packs 502 can be arranged within the wings 404 (e.g., inside of an airfoil cavity), inside nacelles 412, 418, and/or in any other suitable location on the aircraft 400. In a specific example, the energy storage system 500 includes a first battery pack within an inboard portion of a left wing and a second battery pack within an inboard portion of a right wing. In a second specific example, the system includes a first battery pack within an inboard nacelle of a left wing and a second battery pack within an inboard nacelle of a right wing. Battery packs 502 may include a plurality of battery modules 506.

The energy storage system 500 includes a cooling system (such as the fluid circulation system 504) that functions to circulate a working fluid within the battery pack 502 to remove heat generated by the battery pack 502 during operation or charging. Battery cells 508, battery module 506 and/or battery packs 502 can be fluidly connected by the cooling system in series and/or parallel in any suitable manner.

### Electrical Architecture for Aircraft

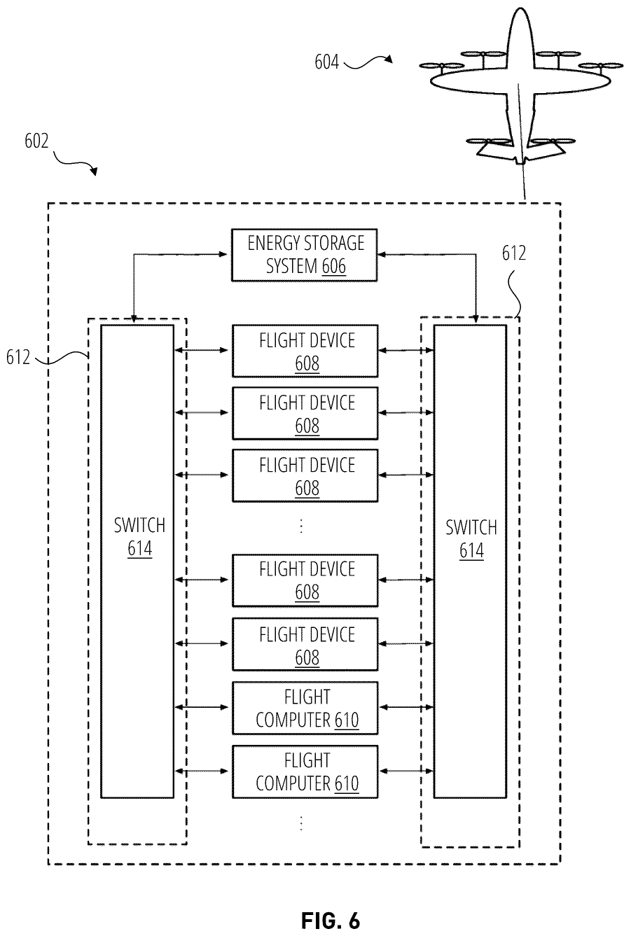

FIG. 6 illustrates an electrical architecture 602 for an aircraft 604. The electrical architecture 602 includes the energy storage system 606, multiple flight devices 608, multiple flight computers 610, and a distribution network 612. Network 612 includes a number of switches 614 and appropriate wired or wireless data-transmission links within the network 612 and with the other components of the electrical architecture 602.

The electrical architecture 602 functions to provide redundant and fault-tolerant power and data connections between the flight device 608, flight computer 610 and the energy storage system 606. The flight devices 608 can include any components related to aircraft flight, including, for example, actuators and control surfaces, such as ailerons, flaps, rudder fins, landing gear, sensors (e.g., kinematics sensors, such as IMUs; optical sensors, such as cameras; acoustic sensors, such as microphones and radar; temperature sensors; altimeters; pressure sensors; and/or any other suitable sensor), cabin systems, and so forth.

The flight computers 610 control the overall functioning of the aircraft 604, including interpreting and transforming flight data into commands that can be transmitted to and interpreted by controllable flight components. Data may be commands, aircraft state information, and/or any other appropriate data. Aircraft state information may include faults (fault indicator, fault status, fault status information, etc.); sensor readings or information collected by flight components such as speed, altitude, pressure, GPS information, acceleration, user control inputs (e.g., from a pilot or operator), measured motor RPM, radar, images, or other sensor data; component status (e.g., motor controller outputs, sensor status, on/off, etc.), energy storage system 606 state information (battery pack voltage, level of charge, temperature and so forth); and/or any other appropriate information. Commands may include faults (fault indicator, fault status, fault status information, etc.); control commands (e.g., commanding rotor RPM (or other related parameters such as torque, power, thrust, lift, etc.), data to be stored, commanding a wireless transmission, commanding display output, etc.); and/or any other appropriate information.

Included with the flight computers 610 are I/O components 702 used to receive input from and provide output to a pilot or other operator. I/O components 702 may for example include a joystick, inceptor, or other flight control input device, data entry devices such as keyboards and touch-input devices, and one or more display screens for providing flight and other information to the pilot or other operator.

One or more of the flight computers 610 also perform the methods described herein for determining the capabilities of the energy storage system 606, based on data received from the I/O components 702, data entered by the pilot, data retrieved from one or more remote servers such as the data repository described below, as well as aircraft and battery state information.

### Computer System

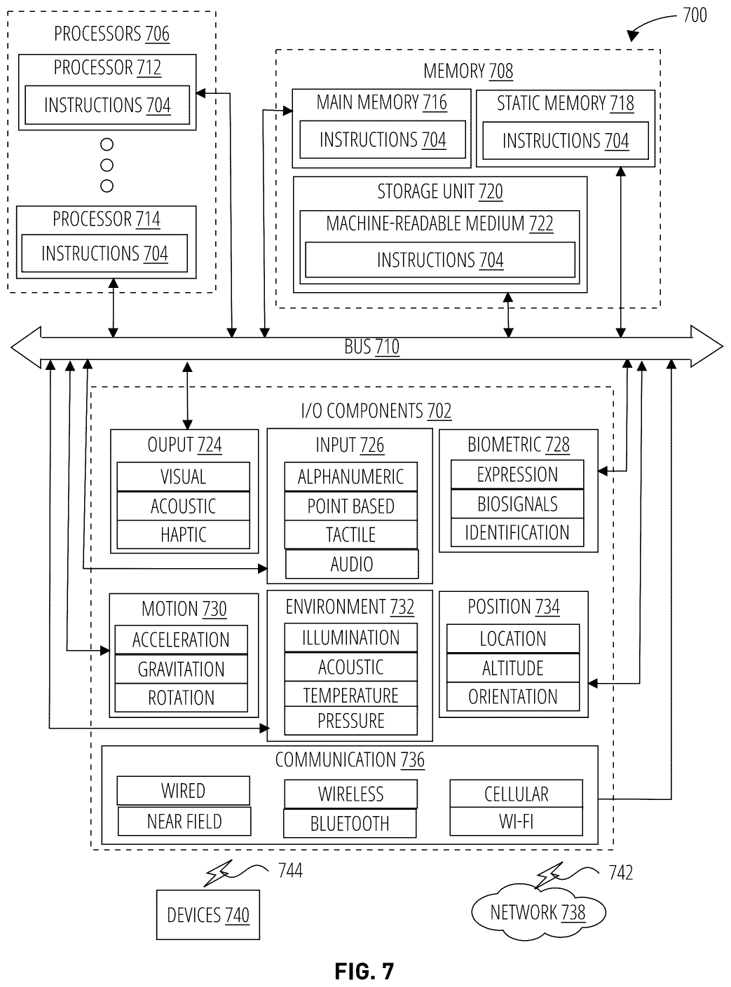

FIG. 7 shows a diagrammatic representation of the machine 700 in the example form of a computer system (e.g., a controller for the POE switch 110) within which instructions 704 (e.g., software, a program, an application, an applet, an app, or other executable code) for causing the machine 700 to perform any one or more of the methodologies discussed herein may be executed. The instructions 704 may transform the general, non-programmed machine 700 into a particular machine 700 programmed to carry out the described and illustrated functions in the manner described. In alternative examples, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. Further, while only a single machine 700 is illustrated, the term “machine” shall also be taken to include a collection of machines 700 that individually or jointly execute the instructions 704 to perform any one or more of the methodologies discussed herein.

The machine 700 may include processors 706, memory 708, and I/O components 702, which may be configured to communicate with each other such as via a bus 710. In some examples, the processors 706 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 712 and a processor 714 that may execute the instructions 704. The term “processor” is intended to include multi-core processors that may comprise two or more independent processors (sometimes referred to as “cores”) that may execute instructions contemporaneously. Although FIG. 7 shows multiple processors 706, the machine 700 may include a single processor with a single core, a single processor with multiple cores (e.g., a multi-core processor), multiple processors with a single core, multiple processors with multiples cores, or any combination thereof.

The memory 708 may include a main memory 716, a static memory 718, and a storage unit 720, both accessible to the processors 706 such as via the bus 710. The main memory 708, the static memory 718, and storage unit 720 store the instructions 704 embodying any one or more of the methodologies or functions described herein. The instructions 704 may also reside, completely or partially, within the main memory 716, within the static memory 718, within machine-readable medium 722 within the storage unit 720, within at least one of the processors 706 (e.g., within the processor's cache memory), or any suitable combination thereof, during execution thereof by the machine 700.

The I/O components 702 may include a wide variety of components to receive input, provide output, produce output, transmit information, exchange information, capture measurements, and so on. The specific I/O components 702 that are included in a particular machine will depend on the type of machine. For example, portable machines such as mobile phones will likely include a touch input device or other such input mechanisms, while a headless server machine will likely not include such a touch input device. It will be appreciated that the I/O components 702 may include many other components that are not shown in FIG. 7. The I/O components 702 are grouped according to functionality merely for simplifying the following discussion and the grouping is in no way limiting. In various examples, the I/O components 702 may include output components 724 and input components 726. The output components 724 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 726 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 702 may include biometric components 728, motion components 730, environmental components 732, or position components 734, among a wide array of other components. For example, the biometric components 728 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 730 may include acceleration sensor components (e.g., accelerometer), gravitation sensor components, rotation sensor components (e.g., gyroscope), and so forth. The environmental components 732 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 734 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 702 may include communication components 736 operable to couple the machine 700 to a network 738 or devices 740 via a coupling 742 and a coupling 744, respectively. For example, the communication components 736 may include a network interface component or another suitable device to interface with the network 738. In further examples, the communication components 736 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 740 may be another machine or any of a wide variety of peripheral devices (e.g., a peripheral device coupled via a USB).

Moreover, the communication components 736 may detect identifiers or include components operable to detect identifiers. For example, the communication components 736 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 736, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., memory 708, main memory 716, static memory 718, and/or memory of the processors 706) and/or storage unit 720 may store data, one or more sets of instructions and data structures embodying or utilized by any one or more of the methodologies or functions described herein. These instructions and models (e.g., the instructions 704), when executed by processors 706, cause various operations to implement the disclosed examples.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various examples, one or more portions of the network 738 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 738 or a portion of the network 738 may include a wireless or cellular network, and the coupling 742 may be a Code Division Multiple Access (CDMA) connection, a Global System for Mobile communications (GSM) connection, or another type of cellular or wireless coupling. In this example, the coupling 742 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 704 may be transmitted or received over the network 738 using a transmission medium via a network interface device (e.g., a network interface component included in the communication components 736) and utilizing any one of a number of well-known transfer protocols (e.g., hypertext transfer protocol (HTTP)). Similarly, the instructions 704 may be transmitted or received using a transmission medium via the coupling 744 (e.g., a peer-to-peer coupling) to the devices 740. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 704 for execution by the machine 700, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

### EXAMPLES

Example 1 is a power over Ethernet switch, comprising: a power supply containing a DC-DC converter configured to input a high-voltage power and output a low-voltage power; a network stack providing Ethernet data signals; and a power distribution system that combines the low-voltage power with the Ethernet data signals and distributes the combined signal; where the power supply, network stack, and power distribution system are integrated into the single power over Ethernet switch.

In Example 2, the subject matter of Example 1 includes, a first heat sink thermally coupled to the power supply; and a second heat sink thermally coupled to the network stack, wherein the first and second heat sinks are thermally isolated from each other to prevent heat transfer between the power supply and network stack.

In Example 3, the subject matter of Example 2 includes, a first inlet vent positioned to direct external air over the first heat sink; a first outlet vent positioned to exhaust air warmed by the first heat sink; and a first independent airflow path defined from the first inlet vent, across the first heat sink, and out the first outlet vent.

In Example 4, the subject matter of Example 3 includes, a second inlet vent positioned to direct external air over the second heat sink; a second outlet vent positioned to exhaust air warmed by the second heat sink; and a second independent airflow path defined from the second inlet vent, across the second heat sink, and out the second outlet vent.

In Example 5, the subject matter of Example 4 includes, baffles positioned between the first and second independent airflow paths to isolate air flowing over the first and second heat sinks.

In Example 6, the subject matter of Examples 2-5 includes, wherein the first heat sink includes fins to increase surface area.

In Example 7, the subject matter of Examples 2-6 includes, a fan configured to force airflow across the first heat sink.

In Example 8, the subject matter of Examples 2-7 includes, thermal interface material positioned between the power supply and the first heat sink.

In Example 9, the subject matter of Examples 1-8 includes, one or more filters coupled to outputs of the DC-DC converter configured to attenuate electrical noise; and an isolator surrounding Ethernet switch integrated circuits of the network stack configured to electrically isolate Ethernet data signals.

In Example 10, the subject matter of Example 9 includes, wherein the one or more filters comprise at least one of an inductor, a capacitor, and a resistor selected to attenuate noise in specific frequency bands.

In Example 11, the subject matter of Examples 9-10 includes, wherein the isolator includes one or more transformers configured to electrically isolate the Ethernet switch integrated circuits.

In Example 12, the subject matter of Examples 9-11 includes, wherein the isolator includes one or more optical components configured to electrically isolate the Ethernet switch integrated circuits.

Example 13 is a method of thermally managing a power over Ethernet switch, comprising: transferring heat from a power supply to a first heat sink; transferring heat from a network stack to a second heat sink; thermally isolating the first and second heat sinks from each other; directing air over the first heat sink using a first airflow path; and directing air over the second heat sink using a second airflow path; wherein the first airflow path and the second airflow path are independent from each other.

In Example 14, the subject matter of Example 13 includes, wherein thermally isolating the first and second heat sinks comprises positioning baffles between the first and second airflow paths to isolate air flowing over the first and second heat sinks and between the first airflow path and the second airflow path.

In Example 15, the subject matter of Examples 13-14 includes, forcing airflow over the first heat sink using a fan.

In Example 16, the subject matter of Example 15 includes, wherein the first heat sink includes fins to increase surface area.

Example 17 is a method of isolating noise in a power over Ethernet switch, comprising: converting a high-voltage input to a low-voltage output using one or more DC-DC converters; filtering the low-voltage output to attenuate electrical noise; and surrounding Ethernet switch integrated circuits with an isolator to electrically isolate network data signals.

In Example 18, the subject matter of Example 17 includes, wherein filtering the low-voltage output comprises passing the output through inductors, capacitors, and resistors selected to attenuate noise in specific frequency bands.

In Example 19, the subject matter of Examples 17-18 includes, wherein the isolator comprises one or more transformers configured to electrically isolate the Ethernet switch integrated circuits.

In Example 20, the subject matter of Examples 17-19 includes, wherein the isolator comprises one or more optical components configured to electrically isolate the Ethernet switch integrated circuits.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A power over Ethernet switch, comprising:
a power supply containing a DC-DC converter configured to input a high-voltage power and output a low-voltage power;
a network stack providing Ethernet data signals; and
a power distribution system that combines the low-voltage power with the Ethernet data signals and distributes the combined signal;
where the power supply, network stack, and power distribution system are integrated into the single power over Ethernet switch.

2. The power over Ethernet switch of claim 1, further comprising:
a first heat sink thermally coupled to the power supply; and
a second heat sink thermally coupled to the network stack,
wherein the first and second heat sinks are thermally isolated from each other to prevent heat transfer between the power supply and network stack.

3. The power over Ethernet switch of claim 2, further comprising:
a first inlet vent positioned to direct external air over the first heat sink;
a first outlet vent positioned to exhaust air warmed by the first heat sink; and
a first independent airflow path defined from the first inlet vent, across the first heat sink, and out the first outlet vent.

4. The power over Ethernet switch of claim 3, further comprising:
a second inlet vent positioned to direct external air over the second heat sink;
a second outlet vent positioned to exhaust air warmed by the second heat sink; and
a second independent airflow path defined from the second inlet vent, across the second heat sink, and out the second outlet vent.

5. The power over Ethernet switch of claim 4, further comprising baffles positioned between the first and second independent airflow paths to isolate air flowing over the first and second heat sinks.

6. The power over Ethernet switch of claim 2, wherein the first heat sink includes fins to increase surface area.

7. The power over Ethernet switch of claim 2, further comprising a fan configured to force airflow across the first heat sink.

8. The power over Ethernet switch of claim 2, further comprising thermal interface material positioned between the power supply and the first heat sink.

9. The power over Ethernet switch of claim 1, further comprising:
one or more filters coupled to outputs of the DC-DC converter configured to attenuate electrical noise; and
an isolator surrounding Ethernet switch integrated circuits of the network stack configured to electrically isolate Ethernet data signals.

10. The power over Ethernet switch of claim 9, wherein the one or more filters comprise at least one of an inductor, a capacitor, and a resistor selected to attenuate noise in specific frequency bands.

11. The power over Ethernet switch of claim 9, wherein the isolator includes one or more transformers configured to electrically isolate the Ethernet switch integrated circuits.

12. The power over Ethernet switch of claim 9, wherein the isolator includes one or more optical components configured to electrically isolate the Ethernet switch integrated circuits.

13. A method of thermally managing a power over Ethernet switch, comprising:
transferring heat from a power supply to a first heat sink;
transferring heat from a network stack to a second heat sink;
thermally isolating the first and second heat sinks from each other;
directing air over the first heat sink using a first airflow path; and
directing air over the second heat sink using a second airflow path;
wherein the first airflow path and the second airflow path are independent from each other.

14. The method of claim 13, wherein thermally isolating the first and second heat sinks comprises positioning baffles between the first and second airflow paths to isolate air flowing over the first and second heat sinks and between the first airflow path and the second airflow path.

15. The method of claim 13, further comprising forcing airflow over the first heat sink using a fan.

16. The method of claim 15, wherein the first heat sink includes fins to increase surface area.

17. A method of isolating noise in a power over Ethernet switch, comprising:
converting a high-voltage input to a low-voltage output using one or more DC-DC converters;
filtering the low-voltage output to attenuate electrical noise; and
surrounding Ethernet switch integrated circuits with an isolator to electrically isolate network data signals.

18. The method of claim 17, wherein filtering the low-voltage output comprises passing the output through inductors, capacitors, and resistors selected to attenuate noise in specific frequency bands.

19. The method of claim 17, wherein the isolator comprises one or more transformers configured to electrically isolate the Ethernet switch integrated circuits.

20. The method of claim 17, wherein the isolator comprises one or more optical components configured to electrically isolate the Ethernet switch integrated circuits.
